(19) United States
(12) Patent Application Publication
(10) Pub. No.: US 2008/0130188 A1
(43) Pub. Date: Jun. 5, 2008

(54) ELECTROSTATIC DISCHARGE DEVICE FOR PORTABLE TERMINAL

(75) Inventors: Yong-Soo JUNG, Suwon-si (KR); Whoe-Sun Yang, Hwaseong-si (KR); Jong-Won Lee, Geumcheon-gu (KR); Ku-Chul Jung, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/947,554

(22) Filed: Nov. 29, 2007

(30) Foreign Application Priority Data
Nov. 30, 2006 (KR) 120146/2006

(51) Int. Cl. H02H 1/00

(52) U.S. Cl. 361/212

(57) ABSTRACT

Disclosed is an electrostatic discharge device for a portable terminal including a main body mounted within the portable terminal. The main body includes a conductor coated with an insulator around the external circumference thereof. In addition, the main body also includes at least one electricity reception portion formed by partially removing the insulator so as to expose the conductor, and an electricity release portion formed by an end of the insulator so as to expose the conductor, wherein the electrostatic electricity generated within the terminal is applied to the electricity reception portion and guided through the conductor. The electrostatic discharge device can be easily installed within the terminal at or adjacent to a position where electrostatic electricity is generated, thereby contributing to miniaturization of a portable terminal.

### PRIORITY

This application claims priority under 35 U.S.C. §119(a) to an application entitled “Electrostatic Discharge Device for Portable Terminal” filed in the Korean Industrial Property Office on Nov. 30, 2006 and assigned Serial No. 2006-120146, the contents of which are hereby incorporated by reference.

### BACKGROUND OF THE INVENTION

1. Field of the Invention

The present invention relates to a portable terminal, and in particular, to an electrostatic discharge device for a portable terminal.

2. Description of the Related Art

The term “portable terminal” typically means an appliance for providing a user-to-user or user-to-service provider wireless communication function through a base station for mobile communication, wherein a sound communication service, a short messaging service, a mobile banking service, and various types of service contents such as TV programs, on-line games, VODs (Videos On Demand), etc., are offered to users through portable terminals. With the epochal development of file compression techniques of music files, etc., like MP3s, mobile phones are improved as multimedia appliances capable of reproducing a music file, a moving image file, or the like, beyond executing a communication function. Due to this, a portable terminal has various uses. As a result, convenient portability has been gradually emphasized for a portable terminal.

In the process of manufacturing portable terminals, ESD (electrostatic discharge) tests are performed. Such ESD tests are performed so as to measure an effect of electrostatic electricity by artificially generating electrostatic electricity and making it penetrate the portable terminal. Electrostatic electricity is generated by relatively moving solids, liquids or gases so that they repeatedly come into contact with each other. Therefore, when a portable terminal comes into contact with a user or an external object, or when the key pad or the like of the portable terminal is manipulated, electrostatic electricity may be generated. Electrostatic electricity moves along various paths under an influence of peripheral devices or components rather than moving along a fixed path, even if the electrostatic electricity were generated at one point. In addition, it is difficult for the electrostatic electricity generated within a portable terminal to be dissipated or discharged to the outside of the portable terminal. In particular, due to the electrostatic electricity, the portable terminal may suffer damage to circuitry or components, and may malfunction. In order to avoid such a problem, a diode, an EMI (electromagnetic interface) pigment, a conductive/insulation tape, etc. are used.

However, such electrostatic discharge means are difficult to apply or mount due to their structural limits. In particular, if it is necessary to mount any of such electrostatic discharge means, a large space is required, which makes it difficult to miniaturize a portable terminal. Furthermore, it is difficult to arrange such an electrostatic discharge means at a position where electrostatic electricity is generated.

### SUMMARY OF THE INVENTION

Accordingly, the present invention has been made to solve the above-mentioned problems occurring in the prior art, and an object of the present invention is to provide an electrostatic discharge device for a portable terminal, which can be easily arranged at a position where electrostatic electricity is generated.

Another object of the present invention is to provide an electrostatic discharge device for a portable terminal capable of contributing to miniaturization of a portable terminal.

In order to accomplish the above-mentioned objects, there is provided an electrostatic discharge device for a portable terminal including a main body mounted within the portable terminal, wherein the main body includes a conductor coated with an insulator around the external circumference thereof, and the main body also includes at least one electricity reception portion formed by partially removing the insulator so as to expose the conductor, and an electricity release portion formed by an end of the insulator so as to expose the conductor, wherein the electrostatic electricity generated within the terminal is applied to the electricity reception portion and guided through the conductor.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of an electrostatic discharge device for a portable terminal according to an embodiment of the present invention; and

FIG. 2 is a top plan view showing the electrostatic discharge device of FIG. 1 provided within a portable terminal.

### DETAILED DESCRIPTION OF THE PREFERRED EMBODIMENT

Hereinafter, preferred embodiments of the present invention will be described with reference to the accompanying drawings. In the following description, the same elements will be designated by the same reference numerals although they are shown in different drawings

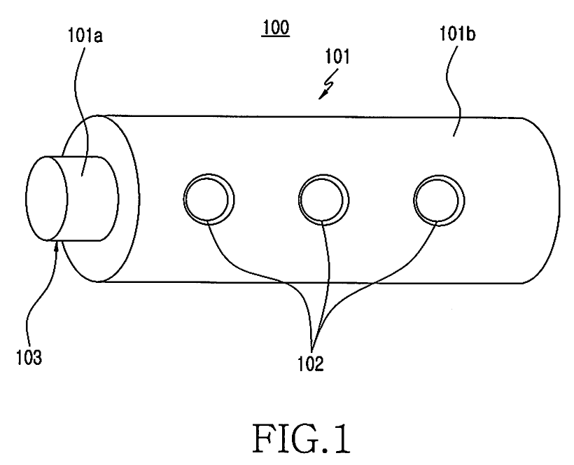

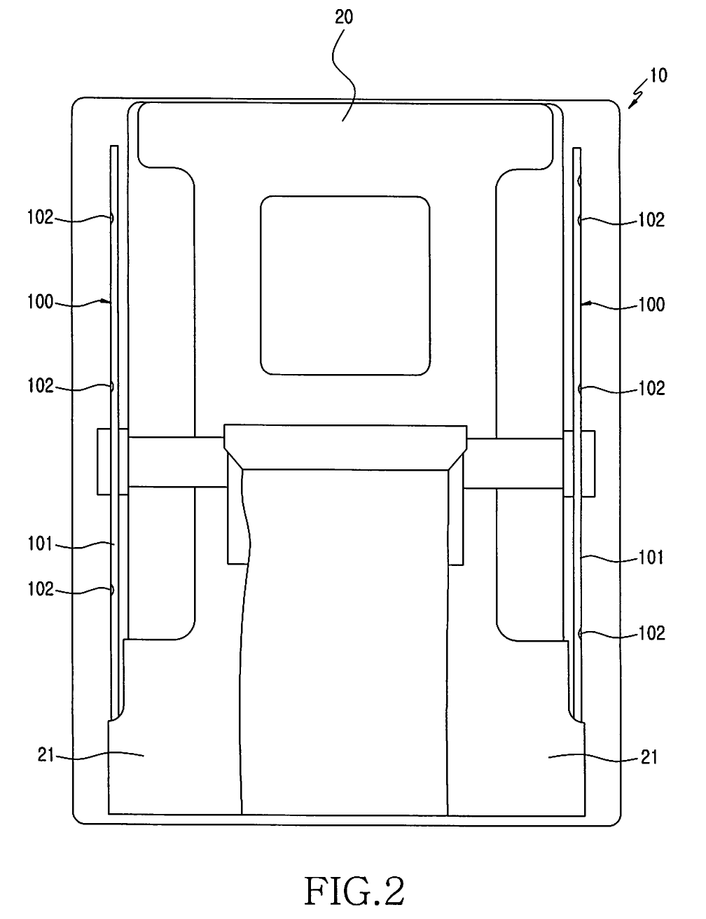

FIG. 1 is a perspective view showing an electrostatic discharge device 100 of a portable terminal according to an embodiment of the present invention. As shown in FIG. 1, the electrostatic discharge device 100 of a portable terminal 10 (see FIG. 2) includes a main body 101.

The main body 101 includes a conductor 101a in a wire shape, and an insulator 101b surrounding the external circumference of the conductor 101b. That is, the conductor 101a is coated with the insulator 101b. In addition, the main body 101 is formed from a soft material and mounted within the terminal 10. The main body 101 includes at least one electricity reception portion 102, and an electricity release portion 103.

The electricity reception portion 102 is formed by partially removing the insulator 101b so as to partially expose the conductor 101a on the outer peripheral surface of the main body 101. When the main body 101 is located within the portable terminal 10, the at least one electricity reception portion is arranged to be opposed to one or more components sensitive to electrostatic electricity or frequently generating electrostatic electricity. The electrostatic electricity generated in the portable terminal 10 is applied to the electricity reception portion 102 and is then guided to a grounding part 21 (see FIG. 2) of a printed circuit board 20 (see FIG. 2) through the main body 10.

At an end of the main body 101, the insulator 101b is partially removed so as to expose the conductor 101a, thereby forming the electricity release portion 103. Although the present embodiment shows a form of the main body formed with an electricity release portion at one end thereof, it is also possible to form such an electricity release portion at each end of the main body.

FIG. 2 is a top plan view showing the electrostatic discharge device 100 provided within the portable terminal 10. As shown in FIG. 2, at least one, and preferably a pair of, electrostatic discharge devices 100 are arranged within the terminal, in particular adjacent to the printed circuit board 20.

A grounding part 21 connected to the electricity release portion 103 is provided on the printed circuit board 20. The electrostatic electricity generated within the terminal 10 is guided by the main body 101, and applied to the grounding part 21 through the electricity release portion 103.

The grounding part 21 is a grounding pattern printed on the printed circuit board 20 of the terminal 10, wherein the grounding part 21 is located at a position remote from a data cable (not shown). Therefore, when electrostatic electricity is applied to the grounding part 21, it is possible to prevent a signal transmitted through the data cable from being distorted, and to prevent the terminal 10 from being damaged or malfunctioning.

In the present embodiment, FIG. 2 shows that the electricity release portions 103 of a pair of main bodies 101 are inserted to the opposite sides of the printed circuit board 20 and connected with a pair of grounding parts 21, respectively. In order to maintain the connection between the electricity release portions 103 and the grounding parts 21, bonding means (not shown), such as soldering or an opposite side adhesive tape, may be employed. The bonding means stably connects the electricity release portions 103 to the grounding parts 21. Therefore, electrostatic electricity can be stably applied to the grounding parts 21.

A process of discharging electrostatic electricity with the above-mentioned electrostatic discharge device 100 will be now described.

At least one electrostatic discharge device 100 is provided within the terminal 10 adjacent to components sensitively reacting with electrostatic electricity or frequently generating electrostatic electricity. Because the main part 101 is formed from a soft material in a wire shape, it can be readily deformed so that it can be readily arranged between associated components. In addition, the main body 101 is arranged in such a manner that one or more electricity reception portions 102 formed on the main body 101 are opposed to one or more positions where electrostatic electricity is generated. At this time, the electricity release portion 103 of the main body 100 is connected to a corresponding grounding part 21.

Electrostatic electricity is generated while the terminal 10 is manipulated, or penetrates the terminal from the outside. The conductor 101a of the main body 101 is surrounded by the insulator 101b, and one or more portions are exposed so as to form one or more electricity reception portions 102. The electrostatic electricity generated within the terminal 10 or introduced into the terminal 10 from the outside is guided to an area, the potential of which is relatively low. Because the main body 101 is connected to the grounding part 21 through the electricity release portion 103, the electrostatic electricity is directly guided to the grounding part 21 or applied to any of the electricity reception portions 102. The electrostatic electricity applied to the electricity reception portion 102 arrives at the conductor 101a through the insulator 101b and flows along the conductor 101a. Therefore, the main body 101 provides a path for guiding electrostatic electricity.

The electrostatic electricity flows along the main body 101 and arrives at the electricity release portion 103 of the main body 101. Because the electricity release portion 103 is connected to the grounding part 21, the electrostatic electricity is applied to the grounding part through the electricity release portion 103, and discharged from the terminal 10. Consequently, the electrostatic discharge device 100 applies electrostatic electricity from the printed circuit board 20 to the grounding part 21, thereby protecting the terminal.

The present embodiment shows an arrangement in which a pair of electrostatic discharge devices 100 are positioned adjacent to the printed circuit board 20. Although not shown in the drawings, however, such an electrostatic discharge device may be positioned within the terminal 10 adjacent to a display device of the terminal 10. At this time, the grounding part connected with the electricity release portion 103 may be arranged at any place within the portable terminal if it is spaced from the data cable and does not interfere with other components.

As described above, the inventive electrostatic discharge device for a portable terminal includes a main body formed with an electricity reception portion and an electricity release portion so as to guide the electrostatic electricity generated in a portable terminal and applied to an electricity reception portion through the main body and to apply the electrostatic electricity to a grounding part connected to the electricity release portion. The main body formed from a soft insulating material in a wire shape is easily deformed, so that it can be easily arranged between associated components adjacent to or at a position where electrostatic electricity is generated. In addition, the inventive electrostatic discharge device allows the space required for mounting it to be reduced, thereby helping miniaturization of a portable terminal.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An electrostatic discharge device for a portable terminal comprising a main body mounted within the portable terminal,
wherein the main body comprises:
a conductor coated with an insulator around the external circumference thereof;
at least one electricity reception portion formed by partially removing the insulator so as to expose the conductor; and
an electricity release portion formed at an end of the insulator so as to expose the conductor, wherein the electrostatic electricity generated within the terminal is applied to the electricity reception portion and guided through the conductor.

2. An electrostatic discharge device as claimed in claim 1, further comprising a grounding part positioned within the terminal and connected with the electricity release portion, the electrostatic electricity being applied to the grounding part through the electricity release portion.

3. An electrostatic discharge device as claimed in claim 1, wherein the grounding part is a grounding pattern printed on a printed circuit board of the terminal, the grounding part being located at a position remote from a data cable of the terminal.

4. An electrostatic discharge device as claimed in claim 2, further comprising a bonding means for maintaining connection between the electricity release portion and the grounding part.

5. An electrostatic discharge device as claimed in claim 4, wherein one of soldering and an opposite side adhesive tape is used as the bonding means.

6. An electrostatic discharge device as claimed in claim 1, wherein the main body is formed in a wire shape from a soft material.
